(19) United States
(12) Patent Application Publication
(10) Pub. No.: US 2026/0265131 A1
(43) Pub. Date: Sep. 10, 2026

(54) CEMENTITIOUS BINDERS AND THEIR PRODUCTION METHODS

(71) Applicant: Nanobet LLC, Yerevan (AM)

(72) Inventors: Davit GRIGORYAN, Yerevan (AM); Smbat MAZMANYAN, Ararat (AM)

(21) Appl. No.: 19/072,048

(22) Filed: Mar. 6, 2025

(51) Int. Cl. C04B 14/02; C04B 14/14; C04B 28/04; C04B 103/40

(52) U.S. Cl. CPC C04B 14/022; C04B 14/14; C04B 28/04; C04B 2103/40

(57) ABSTRACT

A method for production of clinker-free sustainable cementitious binders, low-clinker cementitious binders, clinker-based cementitious binders with enhanced properties, and geopolymer cements through fine grinding of clinker, basalt and/or other cementitious materials with the addition of carbon nanomaterials to the material being fine ground. Resulting binders can serve as an alternative to the conventional clinker-based cementitious binders, either on their own or in combination with other cementitious binders.

### CROSS-REFERENCE TO RELATED APPLICATIONS

This application claims the benefit and priority of U.S. Provisional Patent Applications No. 63/561,763 entitled “Cement, method for producing cement, method for making cement-based composites” filed on Mar. 6, 2024, Nos. 63/719,213 entitled “Binder, method for its production, and composite based on it” filed on Nov. 12, 2024, and 63/761,155 entitled “Carbon nanomaterial-enhanced binders and cements and their production method” filed on Feb. 20, 2025. The entire disclosures of each of the above applications are incorporated herein by reference.

### TECHNICAL FIELD

The present invention relates to cementitious binder, including clinker-free sustainable cementitious binders, low-clinker cementitious binders and clinker-based cementitious binders with enhanced performance characteristics, as well as their production methods.

### BACKGROUND

Since the invention of Portland cement in the 19th century, cement has been the most widely used construction material globally, serving as a critical component of concretes and mortars, and various other construction applications. The wide availability and affordability of the raw materials needed for its production, on the one hand, and its ease of use for making composites, along with the mechanical strength, durability and versatility of such composites, on the other hand, have made cement indispensable in urban development and infrastructure projects.

The production of the most commonly used types of cement, as defined by various national and international standards, including the American ASTM C150 and ASTM C595 standards and the European EN 197-1 standard, relies on the use of clinker due to its exceptional properties as a hydraulic binder.

This dependence on clinker, however, presents significant challenges, as clinker production has a massive environmental footprint and is relatively expensive.

Clinker is produced by burning a raw mixture primarily consisting of limestone and clay at high temperatures (around 1,400-1,500° C.). The calcination process, which is central to clinker formation, not only consumes large amounts of energy but also directly releases substantial amounts of carbon dioxide (CO₂) due to the decomposition of limestone (CaCO₃) into quicklime (CaO). Given the immense scale of global cement production, these factors make it one of the largest contributors to the global carbon dioxide emissions, accounting for approximately 5-8% of total anthropogenic CO₂ annually, as well as other harmful emissions, such as nitrogen oxides (NOₓ).

Furthermore, the consumption of large amounts of essential energy sources, such as natural gas and coal, along with the extraction of raw materials required for clinker production, contributes substantially to the depletion of natural resources.

Reducing clinker content in cement is a key strategy for making cement production more sustainable. However, such reduction can compromise the strength and durability of cement-based composites, unless suitable substitutes or additives are used to compensate for the performance loss. Materials such as blast-furnace slag, silica fume, pozzolana, fly ash, burnt shale, and limestone can serve as clinker substitutes in various applications, though each has certain limitations.

Geopolymer cements have emerged as a more sustainable alternative to the conventional clinker-based cements, delivering the necessary performance in many applications. However, geopolymer cements require alkali activation, which is more complex and demanding compared to the straightforward hydraulic activation of conventional clinker-based cements.

Therefore, innovations related to the development of cements and alternative binders that, compared to conventional cements, have comparable or superior properties, and are more environmentally sustainable, energy-efficient, cost-effective and simple to produce, remain of growing importance.

Research has demonstrated that, due to their unique physicochemical properties, even small dosages of carbon nanomaterials (CNMs) can significantly enhance various performance characteristics of the cement-based composites. A key mechanical property of cement-based composites is their compressive strength, which develops over time.

In a study by Kothiyal et al. (2016), an increase of up to 78% in the compressive strength of cement mortar composites was achieved by incorporating 1 wt. % of graphene oxide (GO) synthesized by applying the Hummers' method to ball-milled commercial graphite powder.

In a study by Barbhuiya et al. (2017), an increase of well over 5% in the compressive strength of cement composites was achieved by adding 0.2 wt. % of carbon nanofibers (CNFs).

In a study by Dimov et al. (2018), a 146% increase in compressive strength and a 79.5% increase in flexural strength of concrete composites were achieved by using water-stabilized graphene dispersions prepared via the high-shear mixing method proposed by Paton et al. (2014), with a graphene concentration of 0.59-0.8 g/L. The researchers also reported that the relevant composites exhibit enhanced electrical and thermal performance, as well as a remarkable reduction in water permeability.

In a study by Qu et al. (2022), a 16.8% increase in the compressive strength of cement-based composites was achieved by adding 0.08 wt. % of carbon dots (CDs).

Most studies on the incorporating CNMs into cement composites have been conducted at the laboratory scale, and it is difficult to scale them up for real-world applications.

One of the obstacles to the broad application of CNMs is that their large-scale production presents significant technological, economic, environmental and health-related challenges. Recent progress in research may help address some of such challenges to various extents.

The abovementioned high-shear mixing methods proposed by Paton et al. (2014), may be promising for large-scale production of high-quality graphene. According to this method a shear force generating a shear rate exceeding 1,000 s ¹ is applied to graphite in a suitable stabilizing liquid to exfoliate and disperse defect-free few-layer graphene (see also Patent U.S. Pat. No. 10,304,937B2).

The method proposed in Patent U.S. Pat. No. 11,772,972B2 utilizes coal (e.g. anthracite, meta-anthracite, semi-graphite) as a source of pre-formed CNMs. According to the patent, mechanically pulverized coal undergoes initial wet comminution without a grinding agent to separate organic content and achieve particle sizes between 200-1,000 nm, followed by wet comminution assisted by grinding agents to obtain nano-carbon polymorphs with particle sizes under 100 nm. The same patent makes a general claim for “application-specific CNM formulations” for cement and concrete modification. However, it does not propose any specific CNM formulations, nor does it propose any method for incorporating any CNM formulation into cement or concrete production.

Another major obstacle to the broad application of CNMs in the construction industry, as outlined in a review by Lu et al. (2022) summarizing the research progress from 2011 to 2021, is their strong tendency to agglomerate, which hinders their uniform dispersion in the cementitious matrix. Since the use of admixtures in cement-based composites has become widespread, various methods for dispersing CNMs in water before mixing it with cement have been investigated, including mechanical shearing, ultrasonication, and surface physiochemical modification. However, as highlighted in the review by Lu et al., even if CNMs are uniformly dispersed in water, they tend to agglomerate upon being mixed with cement due to the high ionic strength resulting from cement dissolution. Such agglomerates introduce defects into the cementitious matrix, weakening it and negating the reinforcing benefits of CNMs. Various methods for incorporating CNMs into dry cement have also been investigated, including shear mixing, high-energy ball milling, and the use of carrier materials. Regular shear mixing has proven inefficient due to the CNM agglomeration. The use of silica fume/nano-silica as a carrier material helps achieve a more uniform distribution of CNMs, but at the cost of severe local agglomeration of CNMs on the carrier surface, therefore only modifying the local chemistry and microstructure around silica fume.

For the reasons mentioned above, adding CNMs to cement, either in dry form prior to composite manufacturing or in wet form during composite manufacturing, is not practical.

While the aforementioned approaches focus on incorporating CNMs into the cementitious matrix after cement production, whether through dry-mixing with cement powder or dispersion into cement slurries and mortars, an alternative strategy involves the integration of CNMs into cement during its production.

Patent document KR20200060096A proposes a cement production method, in which multi-walled carbon nanotubes (MWCNTs) are added to the raw materials used for clinker production. This method has several drawbacks. First, large-scale MWCNT production is technologically complex, has a negative environmental impact and is relatively costly. Second, MWCNTs are not stable at the temperatures required for clinker formation. Third, this method can be applied only by clinker producers, restricting its application in scenarios where clinker is sourced externally.

Patent CN108793792B proposes a cement production method, in which an aqueous dispersion of graphene and/or functionalized graphene (FG) is sprayed onto clinker having a temperature of not less than 150° C., followed by grinding of the cooled down clinker. In particular, this patent refers to the clinker temperature of 250-1380 (more preferably 350-800, and most preferably 500-700). A drawback of this method is that it can be applied only by clinker producers and cannot be applied in scenarios where clinker is sourced externally without additional re-heating of clinker to the needed temperature levels.

Patent document CN112479610A proposes a cement production method, in which carbon nanotubes (CNTs) are added to clinker and certain other materials during grinding. A drawback of this method is that the large-scale production of CNTs is technologically complex, has a negative environmental impact and is relatively costly. Additionally, this method requires supplementary materials, such as calcium bentonite, fly ash, and slag, which may limit its applicability depending on material availability and cost constraints. Another drawback of this method is that it does not address the challenges associated with CNT agglomeration, which can hinder their effective dispersion and their performance in the cementitious matrix.

Furthermore, a key drawback of the methods proposed in the above mentioned documents is that they are related to clinker-based cements. As mentioned above, clinker production has a substantial environmental impact and cost, and its substantial or complete replacement with more sustainable materials, preferably abundant and affordable natural materials, would be highly desirable.

Basalt, which, according to Wikipedia, makes up more than 90% of volcanic rocks on Earth, has traditionally been used in cement-based concrete as an inert aggregate, and is not typically used in cement production.

In a study by Gheller et al. (2022), basalt powder with a particle size of less than 53 μm was prepared and activated with a sodium hydroxide solution. The curing process of the resulting material was carried out in a laboratory oven for 24 hours at five temperature levels: 75, 85, 100, 115, and 125° C. After curing, the compressive strength of the material for the H5S15T125 mixture at 28 days reached a mean value of 10.21 MPa. The drawbacks of this method are that the initial hardening requires high temperatures, and the resulting compressive strength is significantly lower than that provided by the most types of conventional common cements (30 MPa and higher).

In a study by Rashad et al. (2024), the effect of including 2.5-40.0% basalt powder on the properties of geopolymer cement was examined. The inclusion of 2.5-20% basalt powder showed a positive effect, and the optimal amount was determined to be 10%. Thus, according to this study, basalt can play a secondary role and can be used in rather limited proportions.

A U.S.-based company—C-Crete Technologies LLC—announced the development of a cement alternative that could be produced without the high temperatures required for Portland cement production, thereby reducing energy demand. Subsequently, the same company announced that it has successfully used basalt as the primary binder entirely replacing Portland cement. According to the company's statements, the new binder provides compressive strength exceeding 5,000 psi (34.5 MPa). The company's founder, Ruzbeh Savari, mentioned that in the preceding research they had identified around 2,000 formulas, which, however, did not work. The company also announced the development of a granite-based concrete that demonstrates similar or better performance compared to concrete made with Portland cement and maintains cost-parity with conventional concrete. Details about the production methods used for the relevant binders have not been disclosed and remain proprietary.

One of the objects of the present invention is the production of a clinker-free sustainable cementitious binder.

Another object of the present invention is the utilization of basalt sand and basalt dust waste generated during basalt gravel production, thereby reducing the negative environmental impact of such production.

Another object of the present invention is the reduction of the clinker content of the conventional clinker-based cementitious binders without deterioration of their properties.

Another object of the present invention is to provide a method for enhancing the properties of conventional clinker-based cementitious binders by incorporating carbon nanomaterials in small dosages

Another object of the present invention is ensuring homogeneous distribution of carbon nanomaterial particles in the cementitious matrix and prevention of formation of defects due to their agglomeration.

Another object of the present invention is a scalable method of production of cementitious binders with incorporated carbon nanomaterials.

Yet another object of the present invention is the reduction of the cost and environmental impact of production of cementitious binders.

As used herein, the term ‘cementitious binder’ includes both clinker-based cements (e.g. Portland cements) and alternative binders, including hydraulic binders and geopolymer cements.

### SUMMARY

In general, the present disclosure relates to cementitious binders enhanced by CNMs, and the methods of their production. Various embodiments of the present invention relate to methods for producing clinker-free and low-clinker cementitious binders, as well as production methods enhancing the properties of the conventional clinker-based cementitious binders.

In essence, the method provided by the present invention comprises mechanochemical activation of cementitious materials through fine grinding, wherein CNM particles are added to the cementitious materials to be ground prior to and/or during the grinding process to enhance their reactivity and cementitious properties, as well as to ensure the even distribution of the CNM particles in the resulting binder.

According to various embodiments, the disclosed method enables the use of a widely available and affordable natural raw mineral-basalt-as a primary cementitious material for producing clinker-free sustainable cementitious binders that serve as substitutes for conventional Portland cements.

According to various embodiments, when applied to clinker and other cementitious materials, the disclosed method significantly enhances their properties and the properties of the composites made with the resulting cementitious binders, thereby enabling the reduction of the clinker content in conventional cementitious binders without impairing their performance.

The following is a non-exhaustive list of features that may be provided by the method of the present invention, according to various embodiments:
a sustainable cementitious binder containing basalt as the sole cementitious constituent may be obtained;
a water-activated cementitious binder may be obtained;
an alkali-activated cementitious binder may be obtained;
clinker content of conventional clinker-based cementitious binders may be reduced without impairing their properties and the properties of composites made with such binders;
properties of conventional clinker-based cementitious binders may be enhanced;
CNMs may be used in cementitious binder production in the form of a water-based dispersion without surfactants;
a water-based dispersion containing a mixture of different types of CNMs in uncontrolled proportions, obtained through cavitation applied to coal, graphite or another carbon-rich precursor material in a water medium without any surfactants or other chemicals, may be used;
a water-based dispersion containing a mixture of different types of CNMs in uncontrolled proportions, obtained through high shear mixing applied to coal, graphite or another carbon-rich precursor material in a water medium without any surfactants or other chemicals, may be used;
a water-based dispersion containing a mixture of different types of CNMs in uncontrolled proportions obtained through carbonization of mono-, di- or polysaccharides may be used without any surfactants;
a reduction in time of fine grinding of cementitious materials in cementitious binder production can be achieved.

The disclosed method, according to various embodiments, is applicable for production of a wide range of cementitious formulations, offering enhanced sustainability, performance and durability. The disclosed method has been proven to be highly scalable and adaptable across various production environments. It can be integrated into most existing cementitious binder production facilities without requiring significant modifications. The cementitious binders produced according to various embodiments of the present invention can serve as viable alternatives to conventional clinker-based cementitious binders, including those employed in high-performance applications, while providing equivalent or superior properties.

Integration of CNMs into a cementitious binder during its production, according to various embodiments of the present invention, may offer several advantages, as compared to incorporation of CNMs into cementitious matrix after the production of the respective cementitious binder, including:
technical and technological simplicity;
suitability for industrial-scale production;
uniform dispersion and improved chemical integration of CNMs;
enhancement of properties of the cementitious binder;
easier quality control;
lower production costs; and
reduced environmental impact and health hazards.

### BRIEF DESCRIPTION OF THE DRAWINGS

To provide a more comprehensive understanding of the methods of the present invention, further details will be described, including exemplary embodiments, with reference to the accompanying drawings, in which:

FIG. 1 is a schematic depiction of the process of production of a CNM dispersion by applying hydrodynamic cavitation to a carbon-rich precursor material in a water medium;

FIG. 2 is a schematic depiction of the process of production of a CNM dispersion by carbonization of saccharides in an acidic medium; and

FIG. 3 is a schematic depiction of a cementitious binder production process.

### DETAILED DESCRIPTION OF THE INVENTION

In a conventional cementitious binder production process, cementitious materials are subjected to fine grinding to induce their reactivity. According to various embodiments of the present invention, CNM particles are added to the cementitious materials prior to and/or during the grinding process, which ensures or helps ensure even distribution and effective integration of CNM particles in the cementitious matrix, imparting enhanced properties to the resulting cementitious binders and composites made with such binders.

The inventors' research has shown that basalt can be used as a primary cementitious material in case of being mechanochemically activated through fine grinding with the addition of a CNM additive containing CNM particles in the amount of 0.04-2.0 % by weight (wt. %) of dry substance of CNM particles relative to basalt. The CNM particles may be added in the form of a water-based dispersion. The moisture level in the ball mill should be maintained under 1.5%. The properties of basalt mechanochemically activated as per above enable its use as the sole cementitious constituent in a binder, without addition of clinker or any other cementitious material.

According to various embodiments, the disclosed method enables the use of basalt as a primary cementitious material for the production of sustainable alternatives to certain conventional Portland cements.

The inventors' research has further shown that a water-based CNM dispersion containing a mixture of CNM particles of various types and dimensions in uncontrolled proportions, cost-effectively obtained through cavitation applied to pulverized coal or graphite in a water medium without surfactants, can be successfully used for production of a basalt-based cementitious binder by employing a method of the present invention. Although more expensive, a water-based CNM dispersion containing a mixture of CNM particles of various types and dimensions in uncontrolled proportions obtained through carbonization of mono-, di- or polysaccharides in an acidic medium can also be successfully used for production of a basalt-based cementitious binder by employing a method of the present invention.

The inventors' research has also shown that the same method similarly employed in the production of clinker-based cementitious binders in relation to its cementitious constituents significantly enhances the properties of the resulting cementitious binders. Such cementitious binders exhibit greater resistance to aging and environmental degradation, and the composites made with such binders demonstrate significantly higher mechanical strength, thermal stability and reduced water permeability.

According to various embodiments, the disclosed method allows for a substantial enhancement of the properties of the conventional clinker-based cementitious binders and composites made with such binders.

The method of the present invention, according to various embodiments, can also be successfully applied for reducing the clinker content in the conventional clinker-based cementitious binders by partial substitution of clinker with less expensive and more sustainable supplementary cementitious materials (SCMs), such as blast-furnace slag, silica fume, pozzolana, fly ash, burnt shale, and limestone, or such novel cementitious materials as basalt, without impairing, or even with enhancement of, properties of such cementitious binders. Partial replacement of clinker with basalt has proven to lead to a significant increase in the wear resistance and reduction in water permeability of the composites made with the respective cementitious binders.

The present invention will become more apparent to those skilled in the art upon reviewing its embodiments in conjunction with the accompanying drawings.

It should be understood that the following description of exemplary embodiments is provided solely for illustrative purposes and should not be construed as limiting the scope of the invention. The invention is not restricted to the specific embodiments disclosed herein, as various modifications, substitutions, and equivalents will be apparent to those skilled in the art in view of the present disclosure.

Furthermore, the features described in connection with any particular embodiment may be combined with those of other embodiments without departing from the scope of the invention, as defined by the appended claims. Unless otherwise specified, numerical values, material compositions, process parameters, and structural configurations provided herein are illustrative and may vary within reasonable limits to achieve similar results.

Accordingly, the invention is defined by the appended claims and encompasses all modifications and equivalents that fall within their scope.

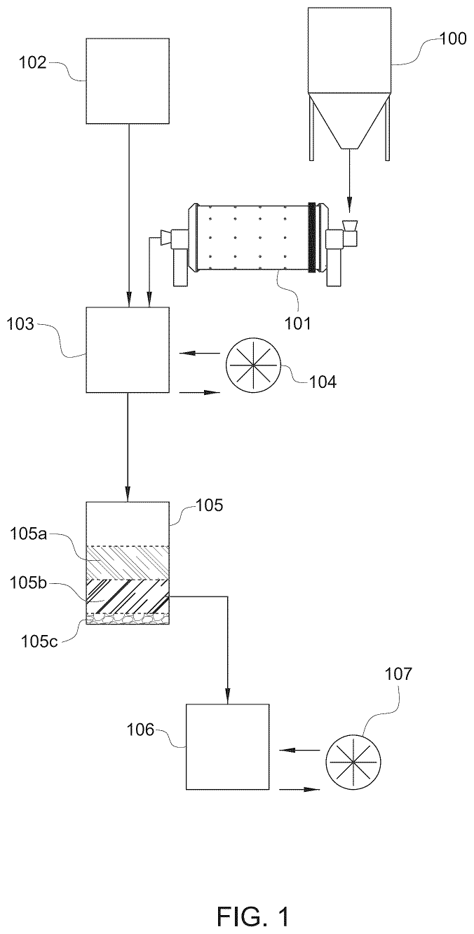

In an exemplary embodiment of the present invention schematically depicted in FIG. 1, a water-based dispersion of CNM particles is obtained through hydrodynamic cavitation applied to coal powder in a water medium.

Coal from a coal storage (100) is supplied to a ball mill (101), where it undergoes dry mechanical comminution until 99% of the pulverized coal passes through an 80 μm sieve.

The pulverized coal from the ball mill (101) and water from a water reservoir (102), in a rate by weight of 1:9 (coal to water), are supplied to a cavitation reservoir (103) without surfactants or other chemicals. The coal-water mixture from the cavitation reservoir (103) undergoes hydrodynamic cavitation in a cavitation-circulation pump (104), leading to:
(1) disintegration of coal particles into CNMs;
(2) deagglomeration, spontaneous functionalization (e.g. oxidation) and activation of CNMs;
(3) homogeneous dispersion of CNMs in the aqueous medium.

The cavitation parameters and duration are optimized to ensure sufficient nano-fragmentation of coal, such that in the resulting water-based dispersion the concentration of CNM particles having a size up to 50 nanometers (nm) in at least one dimension and a size up to 20 micrometers (μm) in each of the other two dimensions reaches approximately 1.5-2.0%. The concentration of larger CNM particles in that dispersion typically reaches approximately 3-4%.

The dispersion from the cavitation reservoir (103) is supplied to a settling reservoir (105), where it undergoes sedimentation for 12 hours for further decantation.

After the sedimentation in the settling reservoir (105), a CNM dispersion (105b), contains heterogeneous CNM particles in uncontrolled proportions, in the amount of nearly 50% of the entire coal-water mixture supplied to the settling reservoir (105) is decanted to a CNM dispersion reservoir (106) for use in a cementitious binder production. The CNM dispersion reservoir (106) is equipped with a high-shear mixer (107) to maintain homogeneous distribution of CNM particles in the dispersion and prevent their agglomeration.

A supernatant liquid (105a) containing a low concentration of CNMs is recycled to the water reservoir (102), and a carbon sediment (105c), after drying, is recycled to the coal storage (100), to minimize waste and increase the effectiveness of further cycles.

In another preferred embodiment of the present invention, the process proceeds as described in [00058] through [00060], after which the dispersion from the cavitation reservoir (103) is mixed with pulverized coal from the ball mill (101) having the characteristics described in [00058] in a rate by weight of 10:1 (dispersion to coal), and the resulting dispersion, having a higher concentration of carbon material, is transferred to the CNM dispersion reservoir (106) skipping the sedimentation and decanting described in [00061]-[00063]. The experimental results achieved from applying this embodiment were somewhat superior to the results achieved from applying the embodiment described in [00057] through [00063] in terms of the mechanical properties of the composites produced from the resulting cementitious binder. Without being bound by any theory, it is believed by the inventors of the present invention that the additional portion of pulverized coal added to the CNM dispersion obtained in result of cavitation facilitates the homogeneous distribution of CNMs in the cementitious binder and, subsequently, in the cementitious matrix. Possibly, an additional amount of CNMs is extracted from the particles of the pulverized coal and evenly distributed in the cementitious binder during the grinding process.

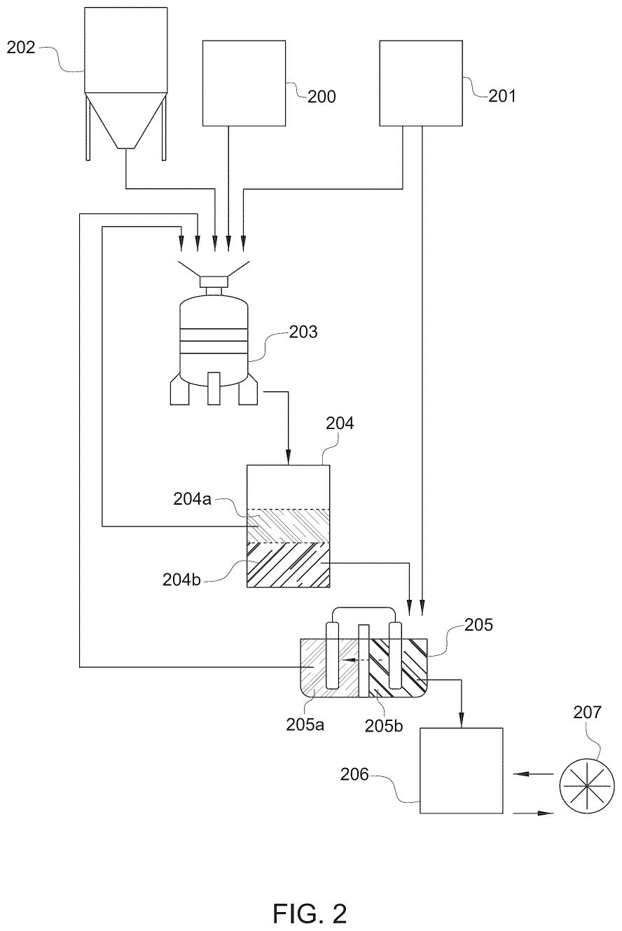

In an exemplary embodiment of the present invention schematically depicted in FIG. 2, a CNM dispersion is obtained through carbonization of saccharides in an acidic medium.

Sulfuric acid H₂SO₄ from a reservoir (200) and water from a reservoir (201) are supplied to a reactor (203) to achieve the acid concentration of 25-30%.

Polysaccharide-containing material (e.g. wheat straw) from a storage (202), in the amount by weight that is equal to the amount by weight of the acid in the reactor (203), is supplied to the reactor (203), in order for the saccharides to undergo carbonization. The carbonization does not require and is conducted without heating. The polysaccharide-containing material should be supplied to the reactor (203) gradually to maintain the temperature within the reactor (203) under approximately 70° C.

The dispersion resulting from the carbonization process described above is supplied from the reactor (203) to a settling reservoir (204).

After settling for 24-48 hours, a sediment (204b) from the settling reservoir (204) and water from the reservoir (201) in the ratio by volume of 1:1 are supplied to a membrane electrolyzer (205), where the acid is removed from the supplied dispersion.

The remaining CNM dispersion (205b), containing heterogeneous CNMs in uncontrolled proportions, is supplied from the membrane electrolyzer (205) to a CNM dispersion reservoir (206) for use in a cementitious binder production. The CNM dispersion reservoir (206) is equipped with a high-shear mixer (207) to maintain homogeneous distribution of CNM particles in the dispersion and prevent their agglomeration.

A supernatant liquid (204a) containing a low concentration of CNMs and an acid portion (205a) are recycled to the reactor (203) to minimize waste and increase the effectiveness of further cycles.

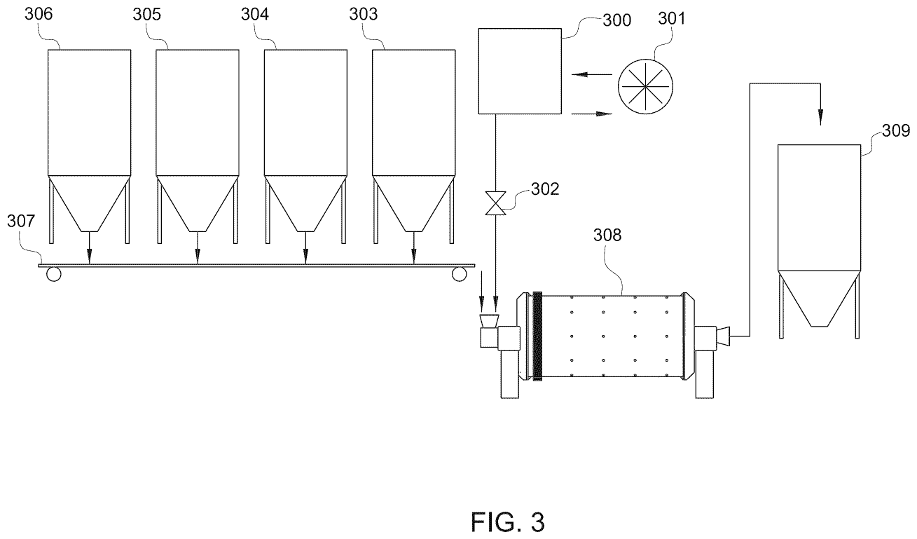

In an exemplary embodiment of the present invention schematically depicted in FIG. 3, a water-based CNM dispersion, which may in a particular embodiment be obtained through cavitation process described above, is stored in a reservoir (300). The reservoir (300) is equipped with a high shear mixer (301) to maintain homogeneous distribution of CNM particles in the dispersion stored in the reservoir (300).

The CNM dispersion from the reservoir (300), via a control valve (302), and dry basalt pre-crushed to a size of 1-5 millimeters (mm) from a basalt storage (303) and dry gypsum from a gypsum storage (304), via a belt conveyor (307), are evenly supplied to a ball mill (308) at a ratio of 0.3:1000:30 by dry substance weight of CNM particles having a size up to 50 nm in at least one dimension and a size up to 20 μm in each of the other two dimensions to weight of basalt to weight of gypsum. The CNM dispersion would typically contain also larger CNM particles in the weight amount that is approximately double the weigh amount of the CNM particles of the sizes mentioned above.

The grinding is performed until the following parameters are achieved:
(1) the retention of the fine ground cementitious material on a 80 μm sieve does not exceed 1%; and
(2) a specific surface area of 3,000-5,000 cm²/g or higher is achieved.

The resulting fine ground material, which constitutes the finished cementitious binder, is transferred from the ball mill (308) to a finished cementitious binder storage (309).

The inventors' experiments show that a cementitious binder produced according to an exemplary embodiment, containing basalt as the sole cementitious constituent with the addition of 0.06-1.0 wt. % of CNM particles, upon water activation and curing achieves the following compressive strength:
over 2 days: from 13.1 to 23.3 MPa;
over 7 days: from 24.0 to 30.3 MPa;
over 28 days: from 36.2 to 41.1 MPa.

In an exemplary embodiment of the present invention schematically depicted in FIG. 3, the CNM dispersion from the reservoir (300), via the control valve (302), and dry basalt pre-crushed to a size of 1-5 mm from the basalt storage (303), clinker from a clinker storage (305), and dry gypsum from the gypsum storage (304), via the belt conveyor (307), are evenly supplied to the ball mill (308) at a ratio of 0.3:1000:30 by dry substance weight of CNM particles having a size up to 50 nm in at least one dimension and a size up to 20 μm in each of the other two dimensions to weight of basalt and clinker together to weight of gypsum, with the clinker content being at least 5 wt. % of the entire mixture. The rest of the process is conducted in the same manner as described in [00074]-[00075].

The inventors' experiments show that cementitious binder produced according to this embodiment with the equal weight percentage of basalt and clinker, upon water activation and curing for 28 days achieves the compressive strength of 46.4-56.8 MPa.

According to various embodiments of the present invention schematically depicted in FIG. 3, the CNM dispersion from the reservoir (300), via the control valve (302), and dry basalt pre-crushed to a size of 1-5 mm from the basalt storage (303), clinker from the clinker storage (305), SCMs from an SCMs storage (306), and dry gypsum from the gypsum storage (304), via the belt conveyor (307), are evenly supplied to the ball mill (308) at a ratio of 0.3:1000:30 by dry substance weight of CNM particles having a size up to 50 nm in at least one dimension and a size up to 20 μm in each of the other two dimensions to weight of basal, clinker and SCMs together to weight of gypsum, with the clinker content being at least 5 wt. % of the entire mixture. The rest of the process is conducted in the same manner as described in [00074]-[00075].

In an exemplary embodiment of the present invention, a clinker-based cementitious binder is produced following a conventional formulation, but with the addition of CNMs as presented above, and with the replacement of up to 15% of the clinker with basalt or SCMs selected from the group of blast-furnace slag, silica fume, pozzolana, fly ash, burnt shale, and limestone. Despite the partial clinker substitution, the cementitious binder produced according to this embodiment exhibits performance characteristics that are not inferior to those of cementitious binder produced according to the relevant conventional formulation without adding CNMs.

In an exemplary embodiment of the present invention, materials rich of CaO or Ca(OH)₂, such as quicklime, hydrated lime, steel slag or ladle slag, are mixed with basalt at a ratio of 1:8-1:20 by weight of such materials to weight of basalt.

In an exemplary embodiment of the present invention, surfactants and/or oxidizing agents are added to the water supplied from the water reservoir (102) to the cavitation reservoir (103).

In an exemplary embodiment of the present invention, a basalt-based cementitious binder produced according to the method of the present invention is a water-activated cementitious binder.

In an exemplary embodiment of the present invention, a basalt-based binder produced according to the method of the present invention is used as a constituent of an alkali-activated cementitious binder or a geopolymer cement.

In an exemplary embodiment of the present invention, a binder is obtained by dry mixing of a basalt-based cementitious binder produced according to the method of the present invention with a conventional clinker-based cementitious binder (e.g. a Portland cement).

A hydraulic clinker-free binder, according to various embodiments, is obtained through a process comprising fine grinding of basalt, wherein a carbon nanomaterial additive is added to basalt prior to and/or during the grinding.

A hydraulic clinker-free binder, according to various embodiments, is obtained through a process comprising fine grinding of cementitious materials, wherein the cementitious materials include basal and at least one cementitious material selected from the group consisting of blast-furnace slag, silica fume, pozzolana, fly ash, burnt shale, limestone or a combination thereof, and a carbon nanomaterial additive is added to the material to be fine ground prior to and/or during the grinding.

A hydraulic cementitious binder according to various embodiments, is obtained through a process comprising fine grinding of cementitious materials, wherein the cementitious materials include clinker and at least one cementitious material selected from the group consisting of basalt, blast-furnace slag, silica fume, pozzolana, fly ash, burnt shale, limestone or a combination thereof, and a carbon nanomaterial additive in the form of a water-based dispersion is added to the material to be fine ground prior to and/or during the grinding.

The foregoing various embodiments have been described to illustrate the features of the present invention without limiting the scope of the claims made herein.

What is claimed is:

1. A method for producing a cementitious binder, the method comprising fine grinding of cementitious materials, wherein:
the cementitious materials include at least one of basalt or clinker;
a carbon nanomaterial additive is added to the cementitious materials to be fine ground in the amount of 0.01-2.0% by weight (wt. %) of dry substance of CNM particles relative to cementitious materials;
the retention of the resulting fine ground cementitious materials on a 80 μm sieve does not exceed 1%; and
the specific surface area of the particles in the resulting finely ground cementitious material, as determined by the Blaine method, is at least 3,000-5,000 cm²/g.

2. The method according to claim 1, wherein the carbon nanomaterial additive includes at least one type of carbon nanomaterial particles selected from the group consisting of graphene, graphene-like structures, graphene quantum dots, graphene nanofibers, carbon nanotubes, carbon nanofibers, carbon nanorings, fullerenes, amorphous carbon nanoparticles and functionalized forms and combinations thereof (CNMs).

3. The method according to claim 1, wherein the carbon nanomaterial additive contains at least two types of CNMs.

4. The method according to claim 1, wherein the carbon nanomaterial additive contains carbon nanomaterial particles having a size up to 50 nanometers in at least one dimension and a size up to 20 micrometers in each of the other two dimensions in the amount from 0.01% to 1.0% by dry substance weight of carbon nanomaterials to the total weight of the cementitious materials to be ground.

5. The method according to claim 1, wherein the carbon nanomaterial additive contains carbon nanomaterial particles having a size exceeding 50 nanometers in all three dimensions and a size exceeding 20 micrometers in at least one dimension in the amount from 0.01% to 1.0% by dry substance weight of carbon nanomaterials to the total weight of the cementitious materials to be ground.

6. The method according to claim 1, wherein the carbon nanomaterial additive is added in more than one stages.

7. The method according to claim 1, wherein the carbon nanomaterial additive is a dispersion comprising water.

8. The method according to claim 1, wherein the carbon nanomaterial additive is a dispersion obtained through a process comprising cavitation applied to coal, graphite or another carbon-rich precursor material in a water medium, and contains carbon nanomaterials of various types and dimensions in unregulated proportions.

9. The method according to claim 1, wherein the carbon nanomaterial additive is a dispersion obtained through a process comprising high shear mixing applied to coal, graphite or another carbon-rich precursor material in a water medium, and contains carbon nanomaterials of various types and dimensions in unregulated proportions.

10. The method according to claim 1, wherein the carbon nanomaterial additive is a dispersion obtained through a process comprising carbonization of at least one of mono-, di- or poly-saccharides, or a mixture thereof, in an acidic medium, and contains carbon nanomaterials of various types and dimensions in unregulated proportions.

11. The method according to claim 1, wherein the carbon nanomaterial additive contains a surfactant.

12. The method according to claim 1, wherein the carbon nanomaterial additive does not contain a surfactant.

13. The method according to claim 1, wherein the cementitious material to be fine ground consists only of basalt.

14. The method according to claim 1, wherein the cementitious material to be fine ground consists only of basalt and clinker.

15. The method according to claim 1, wherein the cementitious materials include at least one type of supplementary cementitious materials selected from the group consisting of blast-furnace slag, silica fume, pozzolana, fly ash, burnt shale, limestone and combinations thereof (SCMs).

16. A hydraulic cementitious binder produced according to claim 1.

17. A hydraulic cementitious binder obtained by mixing the cementitious binder produced according to claim 1 with a Portand cement.

18. An alkali-activated cementitious binder comprising cementitious binder produced according to claim 13.
